(19) United States
(12) Patent Application Publication
(10) Pub. No.: US 2016/0152298 A1
(43) Pub. Date: Jun. 2, 2016

(54) Control Grip for a Vehicle

(71) Applicant: Bayerische Motoren Werke Aktiengesellschaft, Muenchen (DE)

(72) Inventor: Stephan AUGUSTIN, Muenchen (DE)

(21) Appl. No.: 15/019,015

(22) Filed: Feb. 9, 2016

Related U.S. Application Data
(63) Continuation of application No. PCT/EP2014/071501, filed on Oct. 8, 2014.

(30) Foreign Application Priority Data
Oct. 14, 2013 (DE) 10 2013 220 696.8

(51) Int. Cl. B62K 23/04

(52) U.S. Cl. CPC B62K 23/04

(57) ABSTRACT

A control grip, for example a throttle grip, which is designed to control the speed of a vehicle on the basis of an axial torque which is applied to the control grip, includes a gripping region which is designed to be held by the hand of a user, and an attachment region which is designed to attach the gripping region to a component of the vehicle such that it cannot axially rotate. The acceleration and/or the speed of the vehicle depends on the axial torque which is applied to the gripping region by the user. The gripping region and the attachment region are connected to one another in a rigid manner or such that they cannot rotate.

### CROSS REFERENCE TO RELATED APPLICATIONS

This application is a continuation of PCT International Application No. PCT/EP2014/071501, filed Oct. 8, 2014, which claims priority under 35 U.S.C. §119 from German Patent Application No. 10 2013 220 696.8, filed Oct. 14, 2013, the entire disclosures of which are herein expressly incorporated by reference.

### BACKGROUND AND SUMMARY OF THE INVENTION

The present invention relates to a control grip for a vehicle, it being possible for a speed and/or deceleration of a vehicle to be controlled by way of a torque which is applied to the control grip. A grip of this type is also called a throttle grip (also known as an accelerator grip).

In the case of two-wheel, three-wheel or four-wheel vehicles, for example motorcycles, trikes, quad bikes, as well as in the case of snowmobiles and water vehicles, for example a jet ski, what is known as the throttle grip is usually arranged on the handlebar. The throttle grip is configured as a rotary grip and controls the performance output of an internal combustion engine. The decrease in performance is brought about by way of an axial rotation of the throttle grip. The decrease in performance is conventionally controlled by way of a control cable from the throttle grip to the carburetor. Electric throttle grips have been used recently, in which an axial rotational movement of the throttle grip is used to control the acceleration. The signal of an electric throttle grip of this type is transmitted to an electronic engine controller.

An axially rotatable throttle grip on the right-hand handlebar for accelerating two-wheel, three-wheel or four-wheel vehicles and water vehicles has established itself, and users are comfortable using the axially rotatable throttle grip.

Throttle grips of the prior art have disadvantages, however. For example, there is no fixed connection between the right hand of the user and the handlebar of the vehicle. The hand can rotate about the substantially horizontal rotational axis. In addition to the axial play, even high quality throttle grips have a horizontal play along the rotational axis. Furthermore, the wrist of a user is angled away to a greater or lesser extent depending on the driving state, which impairs the ergonomics. The user therefore has to change his/her grip during relatively long journeys, in order to assume a relaxed position when gripping the throttle grip.

The disadvantages of a control grip of the prior art are also relevant to safety, since the brake lever cannot be held using two fingers depending on the rotational position of the throttle grip. For braking purposes, the throttle grip has to be released partially, in order that the brake lever can be actuated. Here, the throttle grip has to return into its idling position, in order that the speed decreases and the vehicle is decelerated.

If the front wheel of the vehicle rises up, for example in the case of excessive acceleration, there is a risk of additional acceleration which goes beyond this, since the user can slide off on the throttle grip and move the latter into a position in which even more engine performance is requested. There is therefore the risk that the front wheel of the vehicle continues to rise up and the dangerous situation escalates.

The mounting of the rotary joint of the throttle grip can be subject to wear and become stiff to operate during its service life. Furthermore, the cable connection of a grip heater of the throttle grip can break and fail as a result of the large number of movements.

Depending on the desired acceleration, the position of the throttle grip is unfavorable and uncomfortable from an ergonomic aspect. For example, the user cannot immediately be supported in an optimum manner during braking and cannot realize the full braking performance. Furthermore, the right hand can wobble in an uncontrolled manner on uneven terrain and can output acceleration requests in an involuntary manner.

In general, the user does not have a secure hold on the handlebar on account of the axial rotatability of the throttle grip and the play of the throttle grip in the longitudinal direction.

The invention has the object of providing a control grip for a vehicle, which control grip makes a secure hold of the user on the vehicle possible.

This and other objects are achieved by way of a control grip, a handlebar, a land vehicle, a water vehicle or an air vehicle in accordance with embodiments of the invention.

A control grip according to the invention which is configured to control the acceleration and/or the speed of a vehicle on the basis of an axial torque which is applied to the control grip includes a gripping region, which is configured to be gripped by the hand of a user, and an attachment region, which is configured to attach the gripping region in a non-rotatable manner to a component of the vehicle. The acceleration and/or the speed of the vehicle depend/depends on the axial torque which is applied to the gripping region by the user. The gripping region and the attachment region are connected to one another in a rigid or non-rotatable manner. The component can be a handlebar. A handlebar is usually a bent tube or a bent rod. The handlebar is attached pivotably to the vehicle and controls the driving direction of the vehicle by way of its angle with respect to the vehicle longitudinal axis.

The expression “axial torque” describes, for example, that a torque acts about the longitudinal direction of the control grip or the gripping region. The longitudinal direction can be the direction of the longer extent of the control grip or the gripping region. Under the assumption that the control grip or the gripping region is of substantially cylindrical configuration, the axial torque can act about the height of the substantially cylindrical control grip or the substantially cylindrical gripping region.

At least one measuring element can be attached to the control grip, which measuring element is configured to determine the axial torque which is applied to the grip region by the user. The measuring element can measure a mechanical stress, a force, a torque, a twist, a torsion, etc.

According to an embodiment of the invention, the grip region cannot be rotated with respect to the attachment region. As a result, the grip region always remains in its original position. As a result, the user of the vehicle can always grip the gripping region of the control grip firmly and securely. The torque which is applied by the user is determined by use of at least one measuring element, for example by use of at least one strain gauge. The expression “axially non-rotatable” does not rule out a twisting or torsion which cannot be perceived by the user. The expression “axially non-rotatable” is intended to rule out an axial rotation which can be perceived or can be perceived clearly by the user.

The expression “axially non-rotatable” describes, for example, that no rotation about the longitudinal direction of the control grip or the gripping region is possible. The longitudinal direction can be the direction of the longer extent of the control grip or the gripping region. Under the assumption that the control grip or the gripping region is of substantially cylindrical configuration, the axial torque can act about the height of the substantially cylindrical control grip or the substantially cylindrical gripping region.

The gripping region and the attachment region can be of integral, that is to say single-piece, configuration. Both the gripping region and the attachment region can be of tubular configuration.

The measuring element can be arranged on a detection region between the gripping region and the attachment region. The detection region can have a greater deformability than the gripping region and the attachment region. The detection region can have a lower material thickness than the gripping region and/or the attachment region. For example, the detection region can be realized by way of a thinner tubular body. Openings can also be provided in the detection region, in order to increase its deformability. It goes without saying that the gripping region, the attachment region and the detection region can be of integral, that is to say single-piece, configuration.

The attachment region can be configured to be attached in an axially non-rotatable manner to a steering device of the vehicle. The control grip can be attached in such a way that it cannot be rotated about the axial axis of the steering device, that is to say of the handlebar. The control grip can be arranged such that it cannot be rotated about the substantially horizontal axis. It goes without saying that the steering device and, therefore, the control grip can be pivoted about the steering axis, that is to say typically about a substantially vertical axis.

The control grip can be assigned a control device which is configured to evaluate the signals of the at least one measuring element in such a way that the axial torque which is applied by the user is determined. It goes without saying that the at least one measuring element determines not only the axial torque, but rather also other forces, for example supporting forces during steering and braking. Furthermore, the control device has to filter vibrations which are caused by ground unevennesses. The control device can be an electronic control device.

The control grip can be configured such that the vehicle can be accelerated and/or decelerated by way of the application of the axial torque to the gripping region. In its rest position in which no torque is applied to the gripping region, a torque can be applied to the gripping region axially in a first direction and a torque can be applied axially in a second direction which is opposed to the first direction, the vehicle accelerating as a result of the application of the torque in the first direction by means of the control device, and the vehicle being decelerated as a result of the application of the torque to the gripping region in the second direction by way of the control device.

Furthermore, the invention relates to a handlebar for a vehicle, the attachment region being configured integrally, that is to say in one piece, with the handlebar of the vehicle.

Furthermore, the invention relates to a land vehicle, a water vehicle or an air vehicle having at least one drive engine and at least one above-described control grip, the drive power of the engine being controlled by way of the application of the axial torque to the grip region. The engine can be an internal combustion engine or electric motor.

Furthermore, the invention relates to a land vehicle, a water vehicle or an air vehicle having at least one braking device and at least one above-described control grip or handlebar, the braking performance of the braking device being controlled by way of the application of the axial torque to the grip region. If the vehicle is driven by an electric drive motor, a braking function can be realized particularly simply, for example by way of recuperation.

The present invention ensures a firm, secure and permanent connection of the driver to the vehicle, as a result of which safety is increased. The control grip according to the invention does not have any play. The optimum grip position is permanently assumed with an ergonomically correct wrist angle. Safety-critical changing of the grip in order to actuate the brake during driving is superfluous. A secure grip contact with respect to the brake lever is permanently possible. The brake lever can be reached quickly and safely. During braking, the supporting forces can be introduced safely. No additional acceleration occurs when the front wheel lifts off. The control grip according to the invention does not have any movable parts, as a result of which its reliability is increased, and the wear and the costs are reduced. Furthermore, a function of the drive moment of the drive engine can be adapted individually to the driving style and the ability of the user and the area of use in a manner which is dependent on the axial torque on the gripping region.

Other objects, advantages and novel features of the present invention will become apparent from the following detailed description of one or more preferred embodiments when considered in conjunction with the accompanying drawing.

### BRIEF DESCRIPTION OF THE DRAWING

FIG. 1 is a sectional view of the control grip according to an embodiment of the invention.

### DETAILED DESCRIPTION OF THE DRAWING

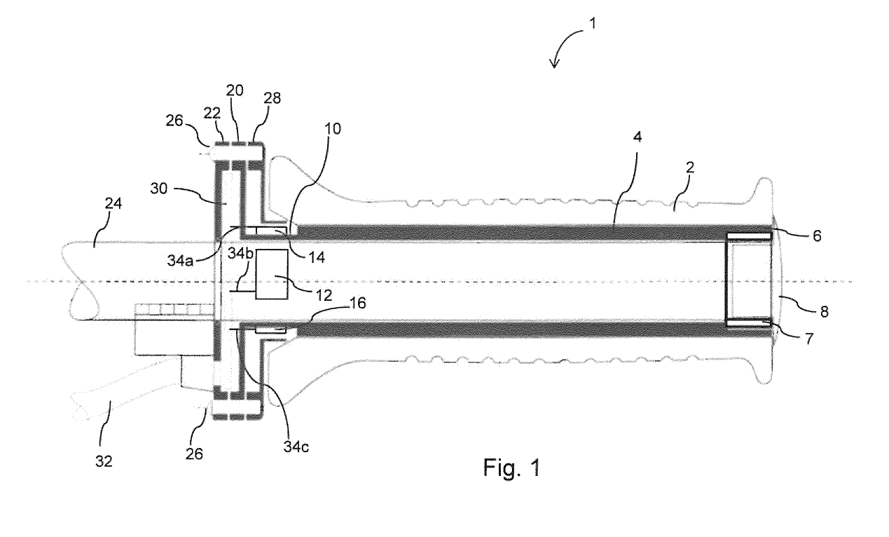

Reference is made to FIG. 1 which shows a section through a handlebar and a control grip 1 of a vehicle. The control grip 1 includes a hand rest 2 and a grip tube 4. The hand rest 2 and the grip tube 4 form the gripping region. A driver of the vehicle, for example of a motorcycle, trike, quad bike, snowmobile, jet ski, etc., uses his/her hand to grip the hand rest 2. The hand rest 2 is connected rigidly to the grip tube 4. In order to control the speed, the driver applies a torque to the grip tube 4 via the hand rest region 2.

The grip tube 4 is connected rigidly and non-rotatably to a handlebar 24 of the vehicle via a detection region 10 and a control grip-side attachment region 20 and a handlebar-side attachment region 22. The torque which is applied by the driver brings about a torsion in the grip tube 4, in the detection region 10, in the attachment regions 20, 22 and in the handlebar 24, since the gripping region 2, 4 is connected rigidly to the handlebar 24. Since the detection region 10 is of a thinner configuration than the grip tube 4, the attachment regions 20, 22 and the handlebar 24, the deformation on account of the torsion occurs mainly or to a relatively great extent in the grip region 10. A plurality of measuring elements, for example strain gauges 12, 14, 16, are arranged in the detection region 10. These measuring elements detect a mechanical stress in the detection region 10 on account of the torsion as a result of the torque which is applied to the gripping region 2, 4 by the driver. A control device or evaluation device 30 detects the signals of the strain gauges 12, 14, 16 via lines 34a, 34b, 34c. A fourth strain gauge (not shown), which is connected electrically to the control device 30, is arranged on the rear side of the detection region 10.

The control device 30 evaluates the measured results of the strain gauges 12, 14, 16 and eliminates supporting forces of the driver on account of the mass thereof on the grip tube 4, the supporting forces of the driver on the grip tube 4 on account of braking, vibrations on account of non-flat terrain, and the like. After elimination of the above-mentioned disturbance variables, the control device 30 determines the torque which is applied to the gripping region 2, 4 by the driver. The control device 30 outputs a signal via a cable 32 to an engine controller (not shown).

The strain gauges 12, 14, 16 are protected against environmental influences by way of a rotationally symmetrical cap 28. Screws 26 connect the attachment regions 20, 22 and the cap 28 to one another rigidly. A plug 8 is introduced into the grip tube 4, in order to seal the control grip 1 and the handlebar 24.

The grip tube 4 has a thinner region 6, on which a bearing sleeve 7 is attached which supports the hand rest 2. The bearing sleeve 7 makes twisting of the grip tube 4 with respect to the handlebar 24 possible. The bearing sleeve 7 also absorbs supporting forces of the driver.

It goes without saying that the attachment regions 20, 22 are not necessarily required. The handlebar 24 can be configured integrally with the grip region 4.

The present invention has the advantage that the gripping region 2, 4 cannot be rotated. As a result, the driver always has a stable hold on the control grip 1 and on the handlebar 24. This measure firstly increases the comfort because the driver does not have to change his/her grip during acceleration and braking. Furthermore, the safety is increased because the driver can always act on the brake grip from a defined and constant wrist position.

The expression “connected rigidly”, the expression “non-rotatable” and the expression “axially non-rotatable” are to be understood from the view of the driver. As a result of the torque which is applied to the gripping region 2, 4 by the driver, merely a torsion which cannot be perceived or can be perceived scarcely by the driver and is detected, for example, in the detection region 10 takes place.

Furthermore, the invention has the advantage that there are no movable parts, as a result of which the service life of the control grip is increased. Furthermore, a torque can be applied axially in both directions to the control grip from its rest position, in which no torque is applied, as a result of which an acceleration and deceleration, for example by way of recuperation, can be controlled.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A control grip configured to control acceleration and/or speed of a vehicle based on an axial torque applied to the control grip, the control grip comprising:
a gripping region configured to be gripped by a hand of a user; and
an attachment region configured to attach the gripping region in an axially non-rotatable manner to a component of the vehicle, wherein
the gripping region and the attachment region are connected rigidly to one another,
the control grip has at least one measuring element configured to determine the axial torque which is applied to the gripping region by the user, and
the acceleration and/or the speed of the vehicle depend on the axial torque which is applied to the gripping region by the user.

2. The control grip according to claim 1, wherein the at least one measuring element comprises a strain gauge.

3. The control grip according to claim 2, wherein:
the at least one measuring element is arranged on a detection region between the gripping region and the attachment region, and
the detection region has a greater deformability than the gripping region and the attachment region.

4. The control grip according to claim 1, wherein:
the at least one measuring element is arranged on a detection region between the gripping region and the attachment region, and
the detection region has a greater deformability than the gripping region and the attachment region.

5. The control grip according to claim 3, wherein the detection region has a lesser material thickness than at least one of the gripping region or the attachment region.

6. The control grip according to claim 1, wherein the attachment region is configured to be attached in an axially non-rotatable manner to a steering device of the vehicle.

7. The control grip according to claim 3, further comprising:
a control device assigned to the control grip,
wherein the control grip is configured to evaluate signals of the at least one measuring element in order to determine the axial torque applied by the user.

8. The control grip according to claim 1, further comprising:
a control device assigned to the control grip,
wherein the control grip is configured to evaluate signals of the at least one measuring element in order to determine the axial torque applied by the user.

9. The control grip according to claim 1, wherein:
from a rest position in which no torque is applied to the gripping region, the torque is applicable axially to the gripping region in a first direction and in a second direction opposed to the first direction, and
as a result of the application of the torque in the first direction, the vehicle is accelerated and,
as a result of the application of the torque in the second direction, the vehicle is decelerated.

10. The control grip according to claim 7, wherein:
from a rest position in which no torque is applied to the gripping region, the torque is applicable axially to the gripping region in a first direction and in a second direction opposed to the first direction, and
as a result of the application of the torque in the first direction, the vehicle is accelerated and,
as a result of the application of the torque in the second direction, the vehicle is decelerated.

11. A handlebar for a vehicle, comprising:
a portion of the handlebar configured for a control grip, wherein the control grip comprises:
a gripping region configured to be gripped by a hand of a user; and
an attachment region configured to attach the gripping region in an axially non-rotatable manner to the portion of the handlebar of the vehicle, wherein
the gripping region and the attachment region are connected rigidly to one another,
the control grip has at least one measuring element configured to determine the axial torque which is applied to the gripping region by the user, and
the acceleration and/or the speed of the vehicle depend on the axial torque which is applied to the gripping region by the user.

12. A vehicle, comprising:
at least one drive engine;
a control grip configured to control acceleration and/or speed of the vehicle based on an axial torque applied to the control grip, the control grip comprising:
a gripping region configured to be gripped by a hand of a user; and
an attachment region configured to attach the gripping region in an axially non-rotatable manner to a component of the vehicle, wherein
the gripping region and the attachment region are connected rigidly to one another,
the control grip has at least one measuring element configured to determine the axial torque which is applied to the gripping region by the user, and
the acceleration and/or the speed of the vehicle depend on the axial torque which is applied to the gripping region by the user.

13. The vehicle according to claim 12, wherein the vehicle is one of a land vehicle, a water vehicle or an air vehicle.

14. The vehicle according to claim 12, wherein the component of the vehicle is a handlebar of the vehicle.

15. A vehicle, comprising:
at least one braking device; and
a control grip configured to control acceleration and/or speed of the vehicle based on an axial torque applied to the control grip, the control grip comprising:
a gripping region configured to be gripped by a hand of a user; and
an attachment region configured to attach the gripping region in an axially non-rotatable manner to a component of the vehicle, wherein
the gripping region and the attachment region are connected rigidly to one another,
the control grip has at least one measuring element configured to determine the axial torque which is applied to the gripping region by the user, and
the acceleration and/or the speed of the vehicle depend on the axial torque which is applied to the gripping region by the user
braking performance of the braking device and/or a recuperation is controlled by way of the application of the axial torque to the gripping region.

16. The vehicle according to claim 15, wherein the component of the vehicle is a handlebar.

17. The vehicle according to claim 15, wherein the vehicle is one of a land vehicle, a water vehicle or an air vehicle.
